(19) United States
(12) Patent Application Publication
(10) Pub. No.: US 2026/0055973 A1
(43) Pub. Date: Feb. 26, 2026

(54) HEAT RECOVERY SYSTEM

(71) Applicant: ZYPHO, SA, Vila Nova De Gaia (PT)

(72) Inventors: José Alberto GARCIA MELIÇO, Sobreda (PT); João Manuel NUNES OLIVEIRA REGO, Alhais (PT)

(21) Appl. No.: 19/099,501

(22) PCT Filed: Jul. 27, 2023
(86) PCT No.: PCT/IB2023/057647

§ 371 Date: Jan. 29, 2025

(30) Foreign Application Priority Data
Jul. 29, 2022 (PT) 118135

(51) Int. Cl. F28D 21/00; E03C 1/00; F28D 7/08; F28D 7/16

(52) U.S. Cl. CPC F28D 21/0012; E03C 1/00; F28D 7/085; F28D 7/1623; E03C 2001/005

(57) ABSTRACT

A heat recovery system (1) suitable for recovering a part of the heat energy from hot water, water from bathing and washing facilities, which is energy that is usually lost when the water is drained into the sewer is provided. This energy can be recovered and reused to heat mains water to be immediately available for use.

### TECHNICAL FIELD

The present invention relates to a heat recovery system suitable to recover heat from hot drain water in bathing and washing facilities.

### BACKGROUND ART

According to the European Commission, buildings are responsible for approximately 40 percent of energy consumption and 36 percent of CO₂ emissions in the European Union. Over recent years, the energy needed to produce hot water has become an ever-larger share of total household energy use at home due to the dramatic fall in energy required for domestic space heating. Recovering heat from shower drains could be a simple way to save at least 40 percent of energy and CO₂ emissions.

Document CA2775456 discloses a heat exchanger placed underneath an elevated tub or shower stall or under the bathroom floor includes a flat top heat conductive plate. The top plate is fastened to a flat lower plate, having a serpentine pattern with a shallow depth embedded into the top surface. In one of the embodiments, it uses round tubes made from heat conductive material, however this solution does not take advantage of an efficient and compact way to convection heat transfer of the hot drain water. The drain water only flows on the top of the tubbing significantly reducing the heat transfer area and the perimeter of the cross-section of the tube in which the hot drain water flows with enough velocity for effective convection heat transfer from the hot drain water to the transverse tubes. This solution is adaptable to bathtubs and shower trays but does not allow to be placed on floor drains where the mechanical requirements of the hollow body are much higher.

Document WO2021054821 discloses a heat exchange system for recovery of heat from shower drain water, and its use, for part of the energy spent in the preparation of hot water, which energy is normally lost when the water is drained into the sewage. This heat recovery device may be applied to the recovery of energy from hot sanitary water, such as the bath water or kitchen water, either from domestic or industrial use. This solution uses the bottom plate with elevated height, thereby shortening the time to completely submerge the heat exchanger in the shower drain water, this makes the tubes to be completely surrounded by hot water which increases transfer area, but unfortunately it makes the drain water flow to have an overall higher height reducing drain hot water flow velocity reducing convention heat transfer and outweighing the gains from the invention, reducing efficiency in a compact solution. The parallel tubes in this solution are far from each other, making this technology too big to achieve high efficiencies. The pipes, being far apart, reduce the turbulence of the sewage water along the walls of the pipes, reducing the efficiency. This solution is constrained to the used of shower tray or of a shower tap, significantly constraining the solution and preventing the invention from being easily adapted to the constraints of domestic sanitary realities.

### SUMMARY

The present invention relates to a heat recovery system (1) suitable for recovering a part of the heat energy from hot water, e.g. water from bathing and washing facilities. This energy can be recovered and reused to heat mains water to be immediately available for use.

### General Description

The present invention relates to a heat recovery system functioning as heat exchanger that makes the recovery of a part of the energy in the form of heat from used water, including water from bathing and washing facilities, which is energy that is usually lost when the water is drained into the sewer. This energy can be recovered and, for example, reused to heat water which can be readily used, for example in the shower, or can be stored in a storage tank.

The heat recovery system is suitable to be placed under or on the side of a bathing and washing facility, such as a shower tray, bathtub floor drain or wash-basin, the used heated water will heat the incoming mains water. This heated water is then directed to either the shower mixer, the water heater or, preferably both, significantly reducing the demand for hot water, reducing energy consumption and improving the energy efficiency.

In general terms, the heat recovery system is constituted by a heat exchanger that comprises parallel tubes that, when installed, become arranged perpendicularly to the used water flow. The heat recovery system has technical improvements that allow to increase the heat recovery efficiency in relation to the known systems in the prior art.

The presently disclosed heat recovery system is suitable for bathing and washing facilities such as residential bath and shower areas, commercial, public, spa, gym or hotel bath and shower areas. This system is designed so that, together with any bathtub, shower tray or floor drain, or even washbasin, constitutes a heat recovery shower tray or a heat recovery bathtub or a heat recovery floor drain or a heat recovery washbasin.

The low height and high efficiency which is possible to accomplish with the present invention is due to the heat exchanger design, by using cylindrical tubes perpendicular to the wastewater flow direction.

With the cylindrical tubes it is possible to obtain a more compact solution when in comparison to using a plain plate, this is because the present invention can have a lot more useful heat transfer surface area by unit of heat exchanger's length, it depends on the diameter of the tubes, and the pitch length between each adjacent cylindrical tube, but the ratio is somewhere between 2 to 4 times more useful heat transfer surface area.

The wastewater flow contours the cylindrical tubes (i.e., parallel tubes) forming a thin film, this creates a thermal boundary layer on the wastewater flow around the cylindrical tube. This thermal barrier is not beneficial for heat transfer; however, the adjacent cylinder tubes disturb the global wastewater flow creating the separation of this thermal boundary layer, the body (i.e., hollow housing) comprises protrusions, which also invoke separation of this thermal boundary layer.

In the present invention there is a lot of versatility of combinations which can be optimized for difference initial conditions of the problem, such as: different wastewater/mains water flow rate, different bath facility install options, different product slopes: which can be used within the installation, different manufacturing costs (for example by using more or less transversal tubes, increasing or diminishing the efficiency accordingly), which makes this invention a complete solution with good efficiency comparing both its manufacturing cost and its overall dimensions.

If a super-efficient solution, or a super compact solution is needed, different combinations of turbulators (or thermal enhancement systems) can be used, this means that with the same amount of tubes or heat transfer surface area it is still possible to increase the overall efficiency of the part by: increasing the flow speed of the cold water/mains water near the walls of the cylindrical tubes, increasing the time/path that the cold water/mains water travels inside the cylindrical tubes, invoking the constant thermal mixing of the cold water/mains water, thus increasing the global thermal gradient of the cold water/mains water in relation to the walls of the cylindrical tubes. It is necessary to have an optimization of the parameters (geometries) of this equipment in order to obtain the maximum possible performance, without compromising the recommended maximum values of pressure loss.

The tube's interior design is discussed below, but the different configurations improve the efficiency of the tube due to: using fins to increase the surface transfer area of the tubes, if the fins have a twist design along the length (helical inner fins), they cause a twist on the cold water flow, increasing the time/path that the cold water travels inside the cylindrical tubes, invoking the constant thermal mixing of the cold water thus increasing the global thermal gradient of the cold water in relation to the walls of the cylindrical tubes.

The tube's exterior design is discussed below, the different configurations improve the efficiency of the tube by increasing the transfer area of the tubes, thus increasing the heat transfer rate, improving efficiency.

The contact between double-walled tubes has also been optimized. Through innovative manufacturing processes it was possible to improve the contact between the walls of the double-walled tubes, the inner tube is constantly exerting pressure on the outer tube, there is also the option of using a thermal layer on the surface between both walls. This makes the contact between the two walls to have a minimum possible of air particles, this reduces with extraordinary capacity the thermal resistance of the contact between both walls significantly increasing the global coefficient of heat transmission improving efficiency.

### BRIEF DESCRIPTION OF DRAWINGS

For easier understanding of this application, figures are attached in the annex that represent the preferred forms of implementation which nevertheless are not intended to limit the technique disclosed herein.

FIGS. 1a, 1b and 1c show embodiments of the heat recovery system;

FIG. 2a shows an embodiment of the hollow housing;

FIGS. 2b, 2c, 2d and 2e show embodiments of the protuberances;

FIGS. 3a, 3b, 3c, 3e, 3f and 3g show embodiments of the heat exchanger;

FIGS. 4a, 4b and 4c show another embodiment of the heat exchanger;

FIGS. 5a, 5b and 5c show another embodiment of the heat exchanger;

FIGS. 6a and 6b show another embodiment of the heat exchanger;

FIGS. 7a, 7b, 7c and 7d show embodiments of the flow guide;

FIG. 8 shows another embodiment of the heat recovery system;

FIGS. 9a, 9b, 9c and 9d show embodiments of the manifolds;

FIGS. 10a, 10b, 10c, 10d, 10e, 10f, 10g and 10h show embodiments of the parallel tubes;

FIGS. 11a, 11b, 11c, 11d, 11e, 11f, 11g, 11 h and 11i show embodiments of turbulators;

FIG. 12 shows the gap between the parallel tubes;

FIG. 13 shows another embodiment of the heat recovery system;

FIG. 14 shows the experimental results of heat recovery efficiency;

FIG. 15 shows the in and out temperature of the mains water and drain water in the heat recovery system.

### DETAILED DESCRIPTION OF EMBODIMENTS

Now, preferred embodiments of the present application will be described in detail with reference to the annexed drawings. However, they are not intended to limit the scope of this application.

The present invention relates to a heat recovery system (1) suitable to recover heat from used heated water.

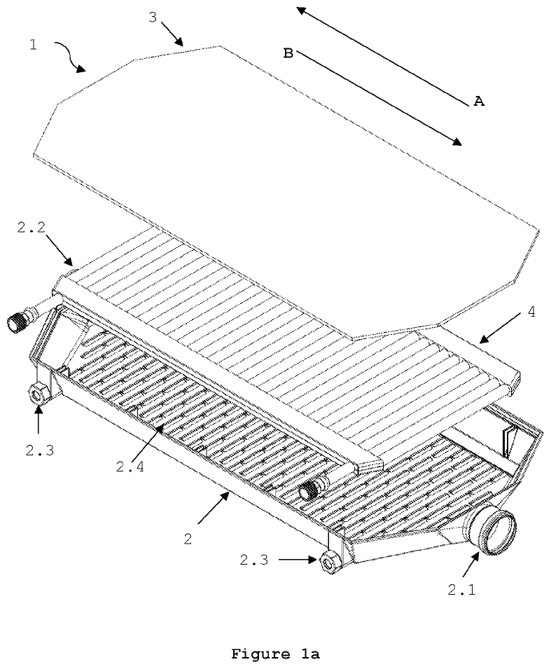

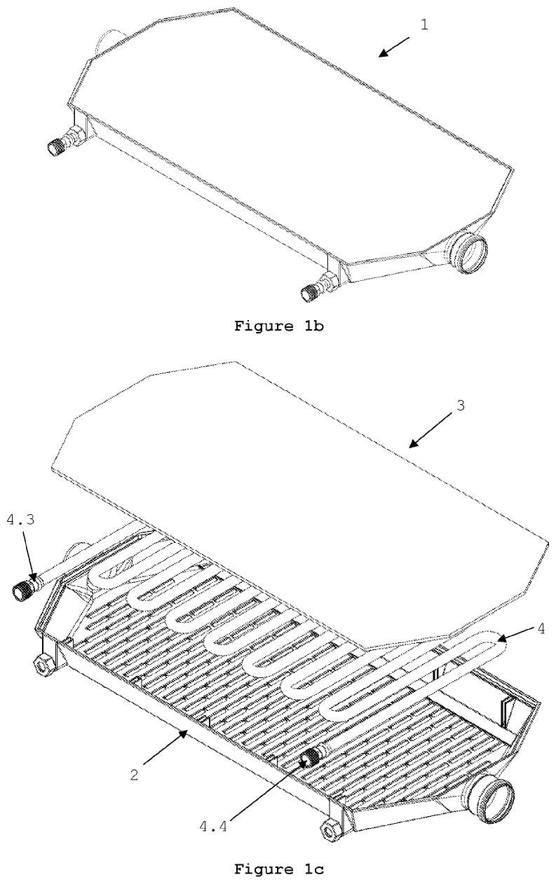

FIGS. 1 to 15, show embodiments of the heat recovery system (1) of the present application.

FIGS. 1a, 1b and 1c show the heat recovery system (1) comprising a hollow housing (2), a heat exchanger (4) and a cover (3).

### Hollow Housing (2)

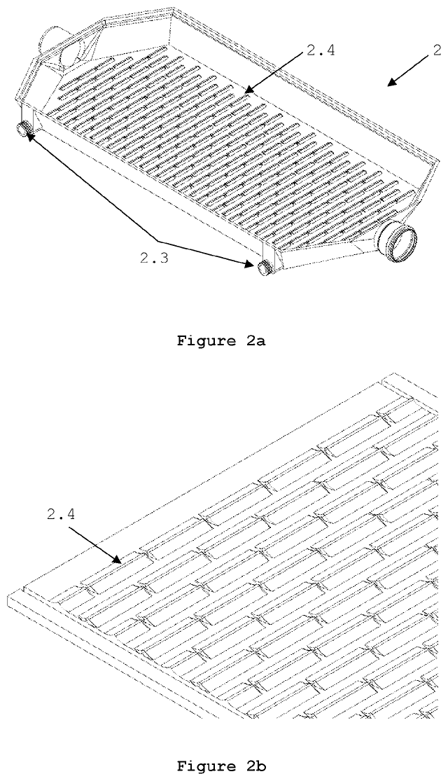

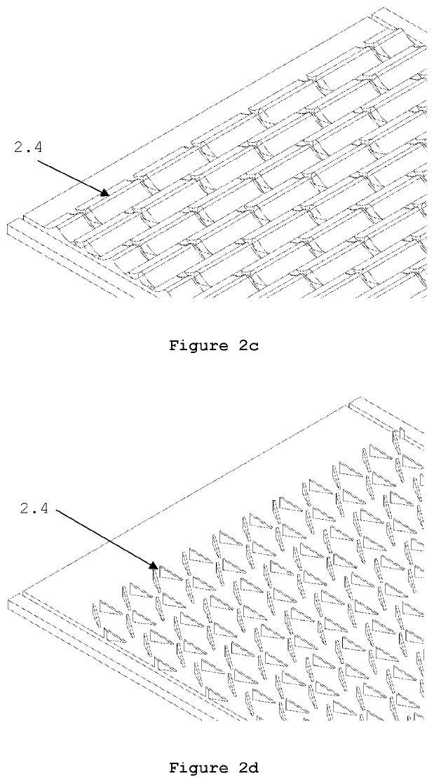

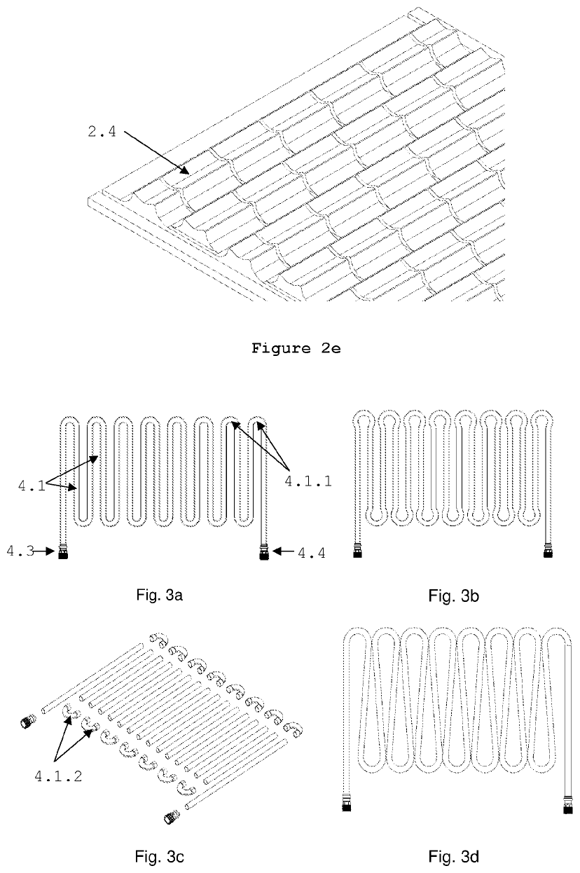

As shown in FIGS. 1a and 2a, the heat recovery system (1) comprises a hollow housing (2) with a drain water inlet (2.1), a drain water outlet (2.2), at least two holes for tubes (2.3) and a removeable cover (3).

In one embodiment, the drain water inlet (2.1) and the drain water outlet (2.2) are arranged on opposite extremities of the hollow housing (2), as shown in FIGS. 1 and 2.

The drain water enters the drain water inlet (2.1), flows inside the hollow housing (2), and exists through the drain water outlet (2.2). Arrow A in FIG. 1a represents the flow direction of the drain water, arrow B represents the flow direction of the mains water.

In one embodiment the hollow housing (2) is made from materials selected from, but not limited to, polypropylene, acrylonitrile butadiene styrene, polyvinyl chloride, or stainless steel.

In one embodiment, the removeable cover (3) is made of polyvinyl chloride, acrylonitrile butadiene styrene, polypropylene or stainless steel.

In one embodiment, the hollow housing (2) has a length between 300 and 900 mm, width between 100 and 400 mm and a height between 30 and 90 mm.

In one embodiment, the hollow housing (2) comprises a plurality of protuberances (2.4) in its interior bottom surface, as shown in FIG. 1a. In one embodiment, the protuberances (2.4) have a height between 0.1 and 10 mm. Examples of some design configurations or shapes of the protuberances (2.4) can be seen in FIGS. 2a to 2e.

All these protuberances (2.4) act as vortex generators, particularly the ones of FIGS. 2d and 2e, increase water flow turbulence increasing the heat transfer efficiency. The turbulence created on the drain water flow between the parallel tubes (4.1) and the hollow case (2) can be optimized with the shape of these protuberances (2.4). It is important to control the drain water flow turbulence in such a way that the total drain water flow, flows with approximately the same amount on the bottom surface of the parallel tubes (4.1) as for their top surface, this all for a given drain water flow, heat recover system's slope, parallel tube (4.1) gap between each other and the hollow case (2).

These protuberances (2.4) also help by separating the thermal boundary layer which is formed across the diameter of the parallel tubes (4.1), this helps increase the overall thermal gradient between the parallel tubes (4.1) and the drain water, thus increasing heat transfer rate.

In another embodiment, as shown in FIG. 2e, the protuberances (2.4) have a double wave shape with a higher height suitable to receive alternating parallel tubes (4.1) when two sets of overlapped heat exchangers (4) are used, this helps to mix the drain water flow, increasing the overall thermal gradient and stabilizing the drain water temperature over the length of the whole heat exchanger.

### Heat Exchanger (4)

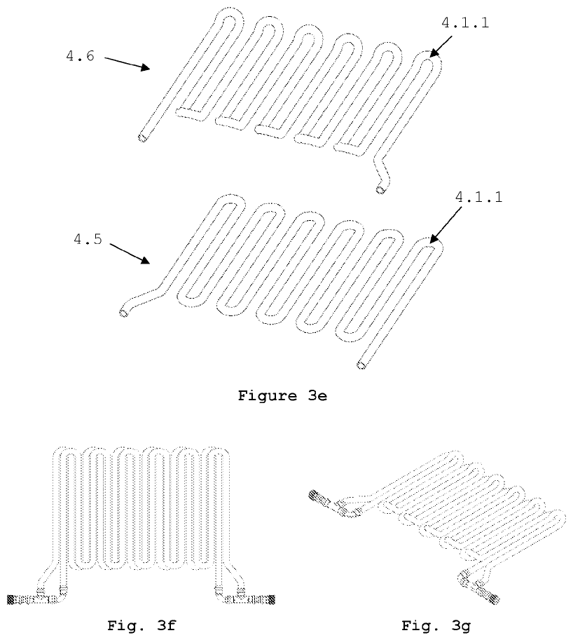

Arranged inside the hollow case (2) is a heat exchanger (4), as shown in FIGS. 3 to 9.

FIG. 1a shows one embodiment of the heat exchanger (4). FIG. 1c shows another embodiment of the heat exchanger (4).

In one embodiment, the heat exchanger (4) has a length between 200 and 800 mm, width between 90 and 390 mm and a height between 10 and 50 mm.

The heat exchanger (4) can assume different shapes and configurations, as shown in FIGS. 1a and 1c, and FIGS. 3 to 9, but in a general embodiment, it comprises a plurality of connected parallel tubes (4.1), a clean water inlet (4.3) and a clean water outlet (4.4).

In the embodiment shown in FIGS. 1c and 3, the heat exchanger (4) comprises a plurality of connected parallel tubes (4.1), a clean water inlet (4.3) and a clean water outlet (4.4).

In the embodiment shown in FIG. 3a, the heat exchanger (4) has a serpentine shape. It comprises a plurality of parallel tubes (4.1) connected on both ends by U-shaped sections (4.1.1). Each U-shaped section (4.1.1) connects two adjacent parallel tubes (4.1).

In the embodiment shown in FIG. 3b that is similar to the one of FIG. 3a, the U-shaped sections (4.1.1) have a hairpin loop shape.

In the embodiment shown in FIG. 3c, the heat exchanger (4) has a serpentine shape. It comprises a plurality of parallel tubes (4.1) connected on both ends by detachable U-shaped sections (4.1.2). Each detachable U-shaped section (4.1.2) connects two adjacent parallel tubes (4.1).

In the embodiment shown in FIG. 3d that is similar to the one of FIG. 3a, the plurality of parallel tubes (4.1) are arranged at an angle with the exception of the first and last parallel tubes (4.1).

In the embodiment shown in FIGS. 3e to 3g, the heat exchanger (4) comprises at least two separate sets of parallel tubes (4.1).

In one embodiment, the first set (4.5) of the heat exchanger (4) has a serpentine shape. It comprises a plurality of parallel tubes (4.1) connected on both ends by U-shaped sections (4.1.1), in which the U-shaped sections are arranged horizontally like the embodiment of FIGS. 3a to 3d. Each U-shaped section (4.1.1) connects two adjacent parallel tubes (4.1). In the same embodiment, the second set (4.6) of the heat exchanger (4) also has a serpentine shape. It comprises a plurality of parallel tubes (4.1) connected on both ends by U-shaped sections (4.1.1), in which the U-shaped sections (4.1.1) project upwards at an angle between 15 and 90°, as shown in FIG. 3e. Each U-shaped section (4.1.1) connects two adjacent parallel tubes (4.1).

In this embodiment, the second set (4.6) is arranged on top of the first set (4.5) in such a manner that the parallel tubes (4.1) of each set intercalate each other as shown in FIGS. 3f and 3g. A joined clean water inlet (4.3) and a joined clean water outlet (4.4) feeds and drains mains water for both sets (4.5, 4.6).

In this embodiment where the two sets are overlapped, the connected parallel tubes (4.1) are closer to each other, reducing the gap (4.1.3) length between the parallel tubes (4.1) and achieving a very compact overall heat exchanger solution. The mains water flow is divided between both sets. In case of using turbulators (5) with this embodiment, their shape is optimized so that the pressure drop of both sets is approximately the same, making sure that the mains water flow is properly divided between both sets, increasing the efficiency of the solution.

In another embodiment, shown in FIG. 1a and FIGS. 4 to 7, the heat exchanger (4) comprises a plurality of connected parallel tubes (4.1), a mains water inlet (4.3), a mains water outlet (4.4) and two manifolds (4.2) (instead of the U-shaped sections (4.1.1)).

The manifolds (4.2) are arranged perpendicularly to the connected parallel tubes (4.1), one manifold (4.2) at each end of the parallel tubes (4.1).

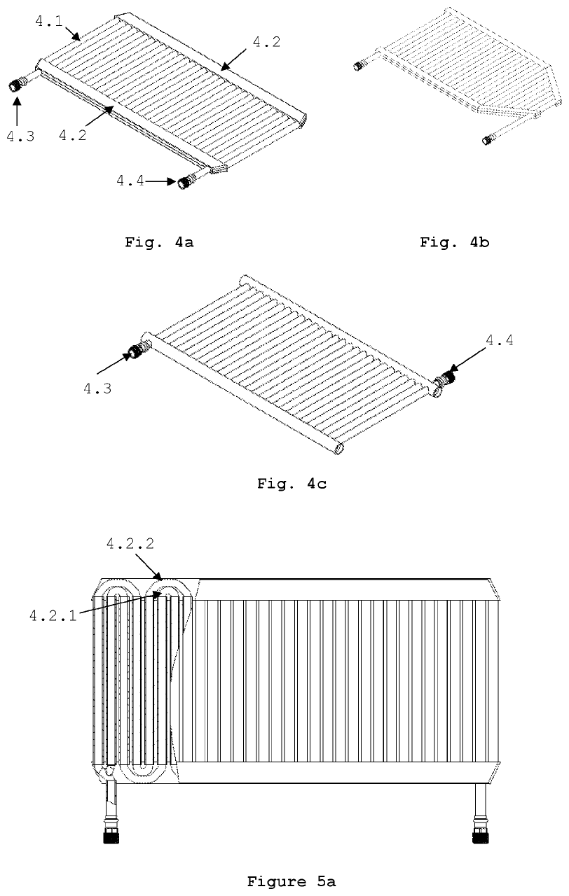

In one embodiment, such as shown in FIG. 4a and FIG. 4c, the heat exchanger (4) has a parallelepipedal shape. In another embodiment, shown in FIG. 4b, the heat exchanger (4) has a portion near the clean water outlet (4.4) that is V-shaped.

The mains water inlet (4.3) and outlet (4.4) can be arranged on the same side of the heat exchanger (4), as shown in FIGS. 4a and 4b, or on opposing sides of the heat exchanger (4) as shown in FIG. 4c. The inlet (4.3) and outlet (4.4) are arranged inside the holes for tubes (2.3) of the hollow case (2). This flexibility helps the installation process of this solution.

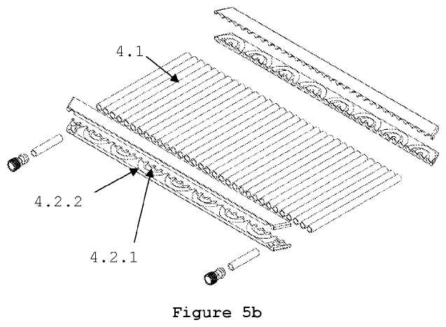

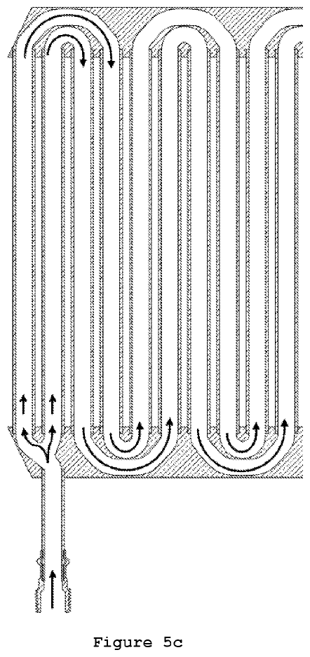

In the embodiment shown in FIGS. 5a, 5b and 5c, the heat exchanger (4) has a serpentine shape. It comprises a plurality of parallel tubes (4.1). Each manifold (4.2) comprises plurality of double U-shaped sections (4.2.1, 4.2.2) with different widths or different curvature radius, that are connected to the parallel tubes (4.1). This embodiment allows to have two intercalated serpentine shapes made by the connected parallel tubes (4.1) and double U-shaped sections (4.2.1, 4.2.2). In this embodiment, the double U-shaped sections (4.2.1, 4.2.2) are part of the manifolds (4.2) themselves. FIG. 5c shows the flow of mains water inside this embodiment of the heat exchanger (4).

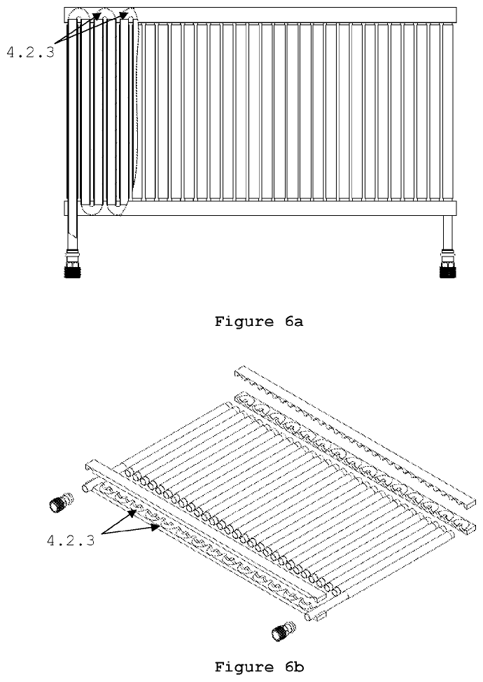

In the embodiment shown in FIGS. 6a and 6b, the heat exchanger (4) has a serpentine shape. It comprises a plurality of parallel tubes (4.1). Each manifold (4.2) comprises a plurality of U-shaped sections (4.2.3), that are connected to the parallel tubes (4.1). A U-shaped section (4.2.2) connects two adjacent parallel tubes (4.1). In this embodiment, the U-shaped sections (4.2.3) are part of the manifolds (4.2) themselves.

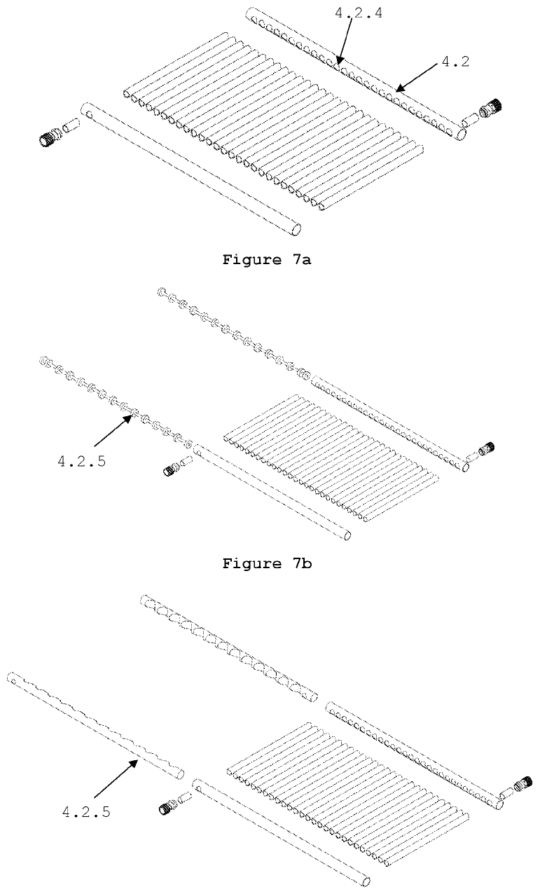

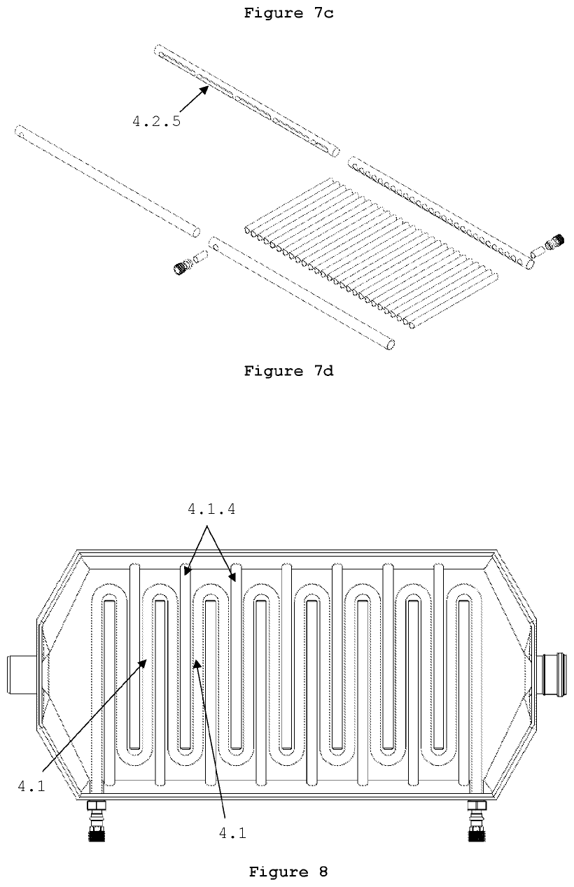

In the embodiment of FIG. 7, the heat exchanger (4) comprises a plurality of parallel tubes (4.1) connected by a manifold (4.2) at each end.

In the embodiment shown in FIG. 7a, the heat exchanger (4) comprises a plurality of parallel tubes (4.1) and two manifolds (4.2). Each manifold (4.2) comprises a plurality of holes (4.2.4), each connected to one parallel tube (4.1). In this embodiment, the water flows through the entirety of the manifold and then to all the parallel tubes (4.1) at the same time.

In one embodiment, each manifold (4.2) can further comprise a flow guide (4.2.5) inside.

In one embodiment, as shown in FIG. 7b, the flow guide (4.2.5) is a rod comprising a plurality of disks along its length.

In one embodiment, as shown in FIG. 7c, the flow guide (4.2.5) is a rod comprising a plurality of notches along its length.

In one embodiment, as shown in FIG. 7d, the flow guide (4.2.5) is a rod comprising a plurality of cavities along its length.

In one embodiment, the manifolds (4.2) are made from a material selected from, but not limited to, stainless steel, brass, aluminum, copper, polyvinyl chloride, acrylonitrile butadiene styrene, polypropylene, or polyoxymethylene.

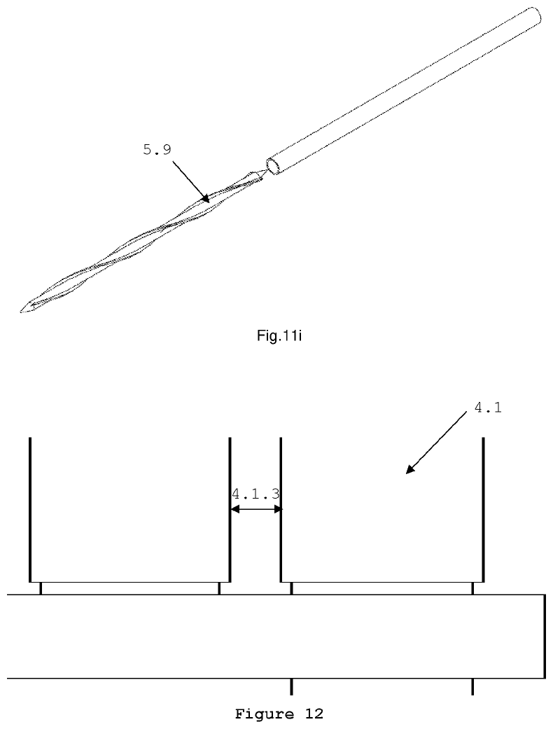

The connected parallel tubes (4.1) are physically separated from each other with a gap (4.1.3), as shown in FIG. 12. There is an optimal gap (4.1.3) length between the parallel tubes (4.1), which depends on the drain water flow, drain water velocity and width of the heat exchanger (4).

In a preferred embodiment, the length (L) of the gap (4.1.3) between each adjacent parallel tube (4.1) is between 0.15 and 2 times the diameter of the parallel tubes (4.1).

Some embodiments of the heat exchanger (4) cannot reach this optimal gap length, when this happens, the heat exchanger (4) comprises additional tubes (4.1.4), in which no mains water flows through them. Each additional tube (4.1.4) is arranged between two adjacent connected parallel tubes (4.1). The purpose for these additional tubes (4.1.4) is only to maintain the optimal drain water flow across the whole heat exchanger (4), an example of this is shown in FIG. 8.

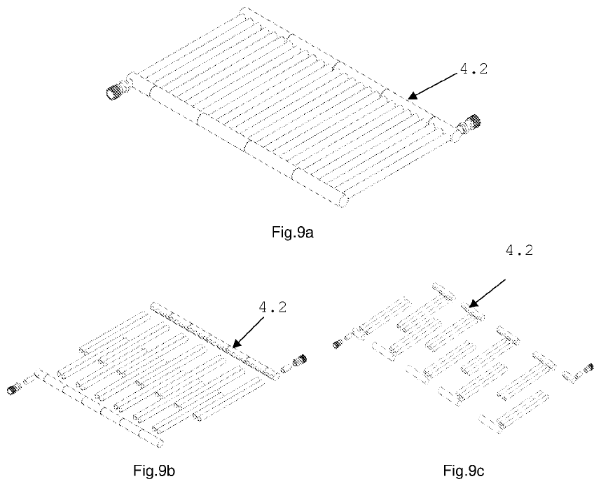

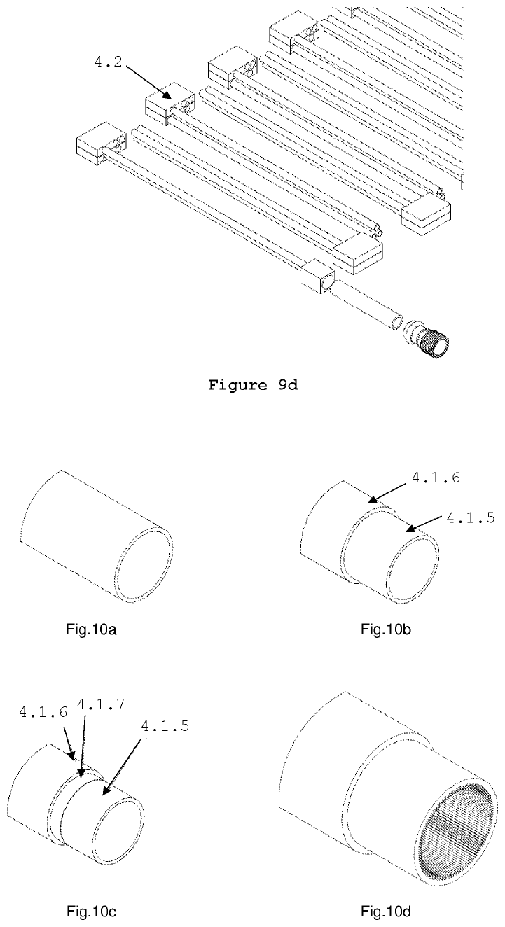

In the embodiment of the heat exchanger (4) in FIG. 9, the manifolds (4.2) are sectioned, and each section is connected to at least four parallel tubes (4.1), as shown in FIGS. 9a to 9c. In this embodiment, the mains water enters each section sequentially.

In the embodiment of FIG. 9d, the manifolds (4.2) are also sectioned, and each section is attached to two sects of at least three parallel tubes (4.1).

The sections of each manifold (4.2) can be attached to at least two parallel tubes (4.1).

Each adjacent section of the embodiments of FIG. 9 are not fluidly connected, i.e., the mains water flows between opposite sections and not between adjacent sections.

### Parallel Tubes (4.1) of the Heat Exchanger (4)

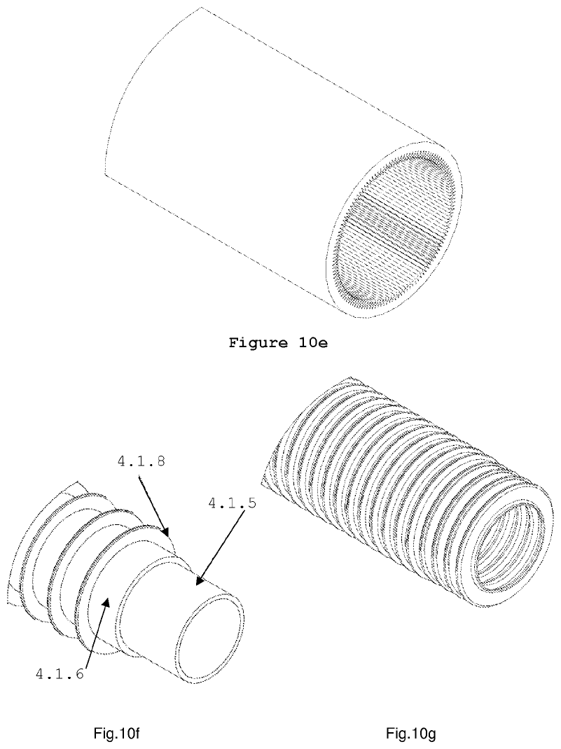

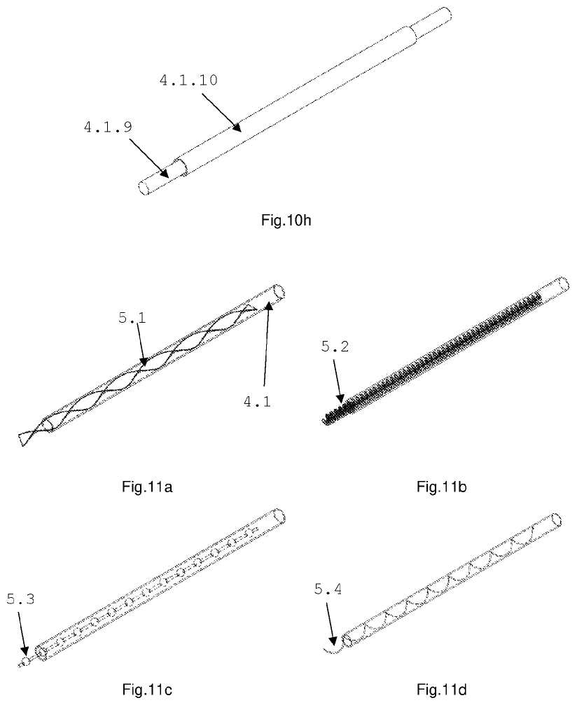

In the embodiment show in FIG. 10a, the parallel tubes (4.1) comprise one wall.

In one embodiment, the parallel tubes (4.1) have a diameter between 6 and 25 mm.

In the embodiment shown in FIG. 10b, the parallel tubes (4.1) comprise two walls, an inner wall (4.1.5) and an outer wall (4.1.6). During the manufacturing process of this embodiment the inner wall (4.1.5) diameter is expanded against the outer wall (4.1.6) in order to increase the contact pressure between the inner wall outer diameter against the outer wall inner diameter, thus diminishing the contact thermal resistance between both walls and greatly increasing the heat transfer.

In the embodiment shown in FIG. 10c, the parallel tubes (4.1) comprise two walls, an inner wall (4.1.5), an outer wall (4.1.6), and a thermal layer (4.1.7) arranged between the two walls. The thermal layer (4.1.7) allows to fill the microscopic imperfections of the parallel tubes (4.1) surfaces, this diminishes the air particles between the outer and inner walls, reducing the contact thermal resistance between both walls and greatly increasing the heat transfer coefficient. In one embodiment, the thermal layer (4.1.7) is made of a thermal compound selected from, but not limited to, synthetic oil, cosmetic grade zinc oxide, mineral spirits, petroleum jelly-based products, cosmetic grade boron nitrate.

In the embodiment shown in FIG. 10d, the parallel tubes (4.1) comprise two walls, an inner wall (4.1.5), an outer wall (4.1.6), and the inner surface of the inner wall (4.1.5) comprises fins. These fins can be longitudinal to the water flow direction or can be twisted as a spiral along the water flow direction. The purpose of the fins is to increase surface area contact between the mains water and the inner wall and also to increase water flow turbulence, hence increasing heat transfer.

In the embodiment shown in FIG. 10e, the parallel tubes (4.1) comprise one wall and its inner surface comprises fins.

In the embodiment shown in FIG. 10f, the parallel tubes (4.1) the parallel tubes (4.1) comprise two walls, an inner wall (4.1.5), an outer wall (4.1.6), and the outer wall (4.1.6) comprises fins (4.1.8). These fins (4.1.8) are arranger transversally to the parallel tube, and longitudinal to the drain water flow direction. The purpose of these fins (4.1.8) is to increase surface area contact between the drain water and the outer wall, increasing heat transfer.

In the embodiment shown in FIG. 10g, the parallel tubes (4.1) comprise an inner wall (4.1.5), an outer wall (4.1.6) in a corrugated shape. This corrugated shape greatly increases the surface contact area between the mains water and the parallel tubes (4.1), and also the surface contact area between the drain water and the parallel tubes (4.1).

In the embodiment shown in FIG. 10h, the parallel tubes (4.1) have a “pipe in pipe” configuration, with a first tube (4.1.9) arranged inside a second tube (4.1.10). In this embodiment the mains water flows between the first and the second tube. This forces the mains water to flow in as a thin film in constant contact with the parallel tubes (4.1) of the heat exchanger (4), this water flow film has high velocity, increasing convention heat transfer rate between mains water and the parallel tube parallel tubes (4.1) wall. The first tube (4.1.9) can be solid or hollow, preferably this first tube has a low thermal capacity in order to not store energy that can be otherwise recovered and reused. In one embodiment, the first tube (4.1.9) can be made of polyvinyl chloride, acrylonitrile butadiene styrene, polypropylene or polyoxymethylene.

This embodiment of FIG. 10h can be combined with all the previous embodiments for the parallel tubes (4.1).

In one embodiment, the parallel tubes (4.1) are made from a material selected from, but not limited to, copper, stainless steel, aluminum, or brass.

The embodiments of parallel tubes described above of one wall or two walls, can be combined with each other.

### Turbulators (5) of the Heat Exchanger (4)

In one embodiment, each parallel tube (4.1) can comprise at least one turbulator (5).

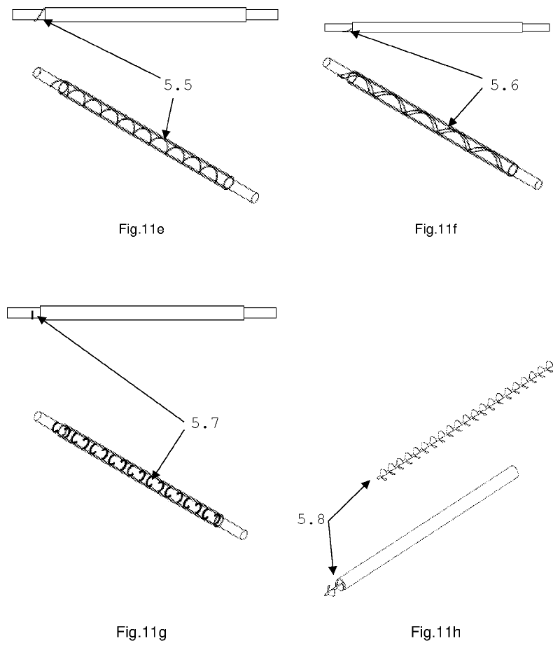

In the embodiment of FIG. 11a, the turbulator (5) has the shape of a twisted tape. This twisted tape turbulator (5.1) disturbs the mains water flow, forcing it to take a longer and twisted flow path. This increases mains water turbulence and increases mains water velocity especially in the areas close to the inner walls of the parallel tube (4.1), hence increases heat transfer rate between the mains water and the parallel tube (4.1).

In the embodiment of FIG. 11b, the turbulator (5) is a matrix turbulator (5.2). This turbulator is composed by a plurality of wire loops along a twisted double wire in the middle. This turbulator increases mains water turbulence, helps to disturb the thermal boundary layer, thus helping to achieve a high thermal gradient between the mains water and the parallel tube (4.1) wall, hence increasing heat transfer rate.

In the embodiment of FIG. 11c, the turbulator (5) is a rod with a plurality of spheres arranged along its length (5.3). Its purpose is to diminish the flow area of the mains water, this increases flow velocity near the parallel tube (4.1) walls, increases turbulence, hence increases heat transfer rate between the mains water and the parallel tube (4.1).

In the embodiment of FIG. 11d, the turbulator (5) is a wire spring (5.4). This turbulator channels the mains water flow to wave across the spring shape, this disturbs the thermal boundary layer, increasing thermal gradient of the mains water in relation to the parallel tube (4.1) wall, hence increasing heat transfer rate.

In the embodiment of the FIG. 11e, the turbulator (5) is a wire spring (5.5), the parallel tubes (4.1) have a “pipe in pipe” configuration, the wire spring turbulator is located between the first tube (4.1.9) and the second tube (4.1.10). These turbulators (5) guide the path of the mains water to make the water flow path longer, increasing useful heat transfer length and thus more efficient heat transfer rate, increase the mains water flow velocity improving convention heat transfer to the tube walls.

In the embodiment of the FIG. 11f, the turbulator (5) is a coil shaped tape spring (5.6), the parallel tubes (4.1) have a “pipe in pipe” configuration, the coil shaped tape spring turbulator is located between the first tube (4.1.9) and the second tube (4.1.10). This turbulator (5.6) guides the path of the mains water to make the water flow path longer, increasing useful heat transfer length and thus more efficient heat transfer rate, increase the mains water flow velocity improving convention heat transfer to the tube walls.

In the embodiment of FIG. 11g, the turbulator (5) is a c-shaped element comprising holes (5.7). A plurality of c-shaped turbulators (5) are arranged along the length of the parallel tube (4.1). These turbulators (5) optimizes the turbulence of the mains water flow, the holes help reduce dead zones (which are areas susceptible to accumulate stagnated mains water which leads to the grown of bacteria, such as Legionella. The holes also allow to maximize the heat transfer recovery area, the holes reduce the mains water pressure drop that might be caused by the use of the c-shaped turbulator. These turbulators (5) help guiding the path of the mains water to make the water flow path longer, increasing useful heat transfer length and thus more efficient heat transfer rate.

In the embodiment of FIG. 11h, the turbulator (5) is a rod comprising a plurality of delta wing vortex generators (5.8). This turbulator (5) makes the mains water to constantly flow in a path that meets the wall of the parallel tube (4.1), also at the edge of this turbulator (5) the mains water curls around the delta wing vortex generator, this makes the mains water flow to have high velocity near the parallel tube (4.1) wall, constant thermal barrier separation. With these delta wing vortex generators, the phenomenon of low temperature mains water which flows undisturbed in the center of the parallel tube (4.1), which is a major disadvantage for the heat transfer rate of the heat exchanger, practically disappears. The vortexes that are generated upstream helps the mains water thermal gradient along the cross section of the parallel tube (4.1) to be as constant as possible. This turbulator (5) enhances heat transfer rate.

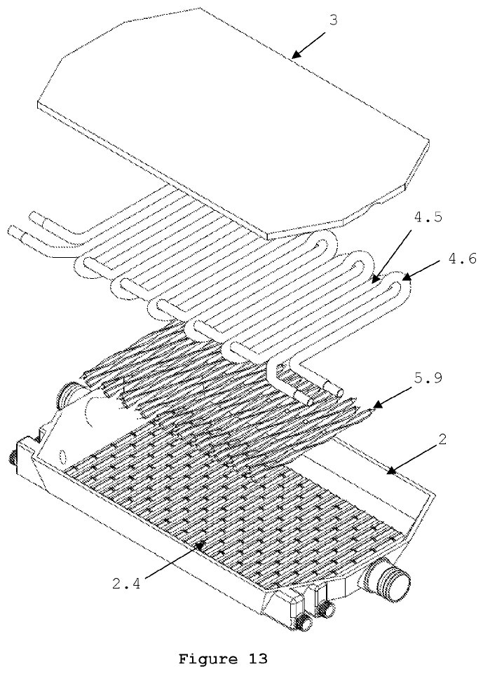

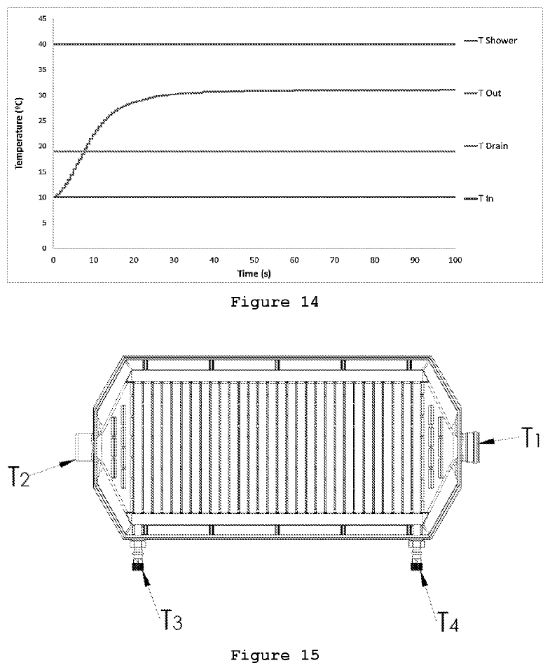

In the embodiment of FIG. 11j, the turbulator (5) is a screw shaped turbulator (5.9). This screw turbulator (5.9) guides the path of the mains water to make the water flow path longer, increasing useful heat transfer length and thus more efficient heat transfer rate, increase the mains water flow velocity improving convention heat transfer to the tube walls. In one embodiment of the present invention, as shown in FIG. 13, the heat recovery system (1) comprises a hollow housing (2) with protuberances (2.4) with a height of 2 mm of the type shown in FIG. 2b, a cover (3), and a heat exchanger (4) of the type shown in FIGS. 3e to 3g with 24 parallel tubes (4.1) (12 tubes per set), and the parallel tubes (4.1) comprise screw turbulators (5.9) inside of the type shown in FIG. 11j.

### Operation Mode

As show in FIG. 15, the drain water flowing from the drain of a bathing and washing facility enters the heat recovery system (1) through the drain water inlet (2.1) at a temperature t1, passes through the inside of the hollow housing (2), above and below the heat exchanger (4) forming a film around the heat exchanger's surface (4), and exits through the drain water outlet (2.2) and into the sewer at a temperature t2.

$$Eff [ \% ] = \frac{{T}_{OUT -} {T}_{IN}}{{T}_{SH} - {T}_{IN}} * 100$$

otherwise (using nomenclature from this application):

$$Eff [ \% ] = \frac{{T}_{4} - {T}_{3}}{{T}_{1} - {T}_{3}} * 100$$

The present invention achieves a heat recovery efficiency between 30 and 80%, as shown in FIG. 14. In this case of FIG. 14: T1=40° C.; T2=19° C.; T3=10° C.; T4=31° C.

The drain water achieves a height between 0.5 and 10 mm inside the hollow case (2) which allows to form a thin film above and under the parallel tubes (4.1) of the heat exchanger (4).

As shown in FIG. 15, the mains water enters the heat exchanger (4) through a water inlet (4.3) at a temperature t3, flows inside the parallel tubes (4.1) and manifolds (4.2), exchanging heat with the drain water flowing outside the heat exchanger (4), and exits the heat exchanger (4) through the mains water outlet (4.4) at a temperature t4.

The heat exchange system (1) can be arranged in the bathing and washing facility, for example in a bath or shower tray, in such a way that the parallel tubes (4.1) are arranged perpendicularly to the flow of the drain water. The connections of the drain water inlet (2.1) and drain water outlet (2.2) are built according to standard sizes of international plumbing regulations and best practices. When installed in a set with a shower tray with high velocity drain capabilities, the drain flow inlet velocity is maximized and thus greater water flow velocity boosting convection heat transfer and increasing efficiency.

The heat exchanger system (1) when using a double walled embodiment on the parallel tubes (4.1), the heat exchanger (4) has safety means to where the water is channeled when a leak happens, a leakage detect system. A leakage gap between the walls makes it possible to immediately detect inner or outer tube's ruptures. This leaked water is channeled between the inner and outer tube walls, until reaching a safety zone outside or inside the hollow body, where this leak can be detected and lead to immediate action assuring no contamination of mains water during this process.

This description is of course not in any way restricted to the forms of implementation presented herein and any person with an average knowledge of the area can provide many possibilities for modification thereof without departing from the general idea as defined by the claims. The preferred forms of implementation described above can obviously be combined with each other. The following claims further define the preferred forms of implementation.

1. A heat recovery system (1) comprising a hollow housing (2), a heat exchanger (4) and a removeable cover (3); wherein:
the hollow housing (2) with a drain water inlet (2.1), a drain water outlet (2.2), at least two holes for tubes (2.3), and comprises a plurality of protuberances (2.4) in its interior bottom surface;
the heat exchanger (4) has a serpentine shape and is arranged inside the hollow case (2) and comprises a plurality of connected parallel tubes (4.1), a clean water inlet (4.3) and a clean water outlet (4.4); wherein the parallel tubes (4.1) are separated with a gap (4.1.3) that has a length between 0.15 and 2 times the diameter of the parallel tubes (4.1).

2. The heat recovery system (1) according to claim 1, wherein the plurality of parallel tubes (4.1) is connected on both ends by U-shaped sections (4.1.1), each U-shaped section (4.1.1) connects two adjacent parallel tubes (4.1).

3. The heat recovery system (1) according to claim 1, wherein the plurality of parallel tubes (4.1) is connected on both ends by detachable U-shaped sections (4.1.2), each detachable U-shaped section (4.1.2) connects two adjacent parallel tubes (4.1).

4. The heat recovery system (1) according to claim 1, wherein the heat exchanger (4) comprises at least two separate sets of parallel tubes (4.1), the first set (4.5) has a serpentine shape and comprises a plurality of parallel tubes (4.1) connected on both ends by U-shaped sections (4.1.1), the second set (4.6) has a serpentine shape and comprises a plurality of parallel tubes (4.1) connected on both ends by U-shaped sections (4.1.1), in which these U-shaped sections (4.1.1) project upwards at an angle between 15 and 90°; and the second set (4.6) is arranged on top of the first set (4.5) in such a manner that the parallel tubes (4.1) of each set intercalate each other.

5. The heat recovery system (1) according to claim 1, wherein the heat exchanger (4) comprises two manifolds (4.2) arranged perpendicularly to the parallel tubes (4.1), one manifold (4.2) at each end of the parallel tubes (4.1).

6. The heat recovery system (1) according to claim 5, wherein each manifold (4.2) comprises a plurality of double U-shaped sections (4.2.1, 4.2.2) with different widths or different curvature radius, that are connected to the parallel tubes (4.1) having two intercalated serpentine shapes made by the connected parallel tubes (4.1) and double U-shaped sections (4.2.1, 4.2.2), and the double U-shaped sections (4.2.1, 4.2.2) are part of the manifolds (4.2) themselves.

7. The heat recovery system (1) according to claim 5, wherein each manifold (4.2) comprises a plurality of U-shaped sections (4.2.3), that are connected to the parallel tubes (4.1), each U-shaped section (4.2.2) connects two adjacent parallel tubes (4.1), and the U-shaped sections (4.2.3) are part of the manifolds (4.2) themselves.

8. The heat recovery system (1) according to claim 5, wherein each manifold (4.2) comprises a plurality of holes (4.2.4), each connected to one parallel tube (4.1).

9. The heat recovery system (1) according to claim 5, wherein each manifold (4.2) comprises a flow guide (4.2.5) inside selected from a rod comprising a plurality of disks along its length, a rod comprising a plurality of notches along its length, or a rod comprising a plurality of cavities along its length.

10. The heat recovery system (1) according to claim 5, wherein the manifolds (4.2) are sectioned, and each section is connected to at least two parallel tubes (4.1).

11. The heat recovery system (1) according to claim 5, wherein the manifolds (4.2) are made from a material selected from stainless steel, brass, aluminum, copper, polyvinyl chloride, acrylonitrile butadiene styrene, polypropylene, or polyoxymethylene.

12. The heat recovery system (1) according to claim 5, wherein the heat exchanger (4) comprises additional tubes (4.1.4), each additional tube (4.1.4) is arranged between two adjacent connected parallel tubes (4.1).

13. The heat recovery system (1) according to claim 5, wherein the heat exchanger (4) has a parallelepipedal shape or has a portion near the clean water outlet (4.4) that is V-shaped.

14. The heat recovery system (1) according to claim 1, wherein the parallel tubes (4.1) have a diameter between 6 and 25 mm.

15. The heat recovery system (1) according to claim 1, wherein the parallel tubes (4.1) comprise one wall.

16. The heat recovery system (1) according to claim 1, wherein the parallel tubes (4.1) comprise two walls, an inner wall (4.1.5) and an outer wall (4.1.6).

17. The heat recovery system (1) according to claim 16, wherein a thermal layer (4.1.7) is arranged between the two walls, the thermal layer compound is selected from synthetic oil, cosmetic grade zinc oxide, mineral spirits, petroleum jelly-based products or cosmetic grade boron nitrate.

18. The heat recovery system (1) according to claim 16, wherein and the inner surface of the inner wall (4.1.5) comprises fins.

19. The heat recovery system (1) according to claim 16, wherein and the outer wall (4.1.6) comprises fins (4.1.8).

20. The heat recovery system (1) according to claim 16, wherein the inner wall (4.1.5) and outer wall (4.1.6) have a corrugated shape.

21. The heat recovery system (1) according to claim 1, wherein the parallel tubes (4.1) have a “pipe in pipe” configuration, with a first tube (4.1.9) arranged inside a second tube (4.1.10).

22. The heat recovery system (1) according to claim 1, wherein the parallel tubes (4.1) are made from a material selected from copper, stainless steel, aluminum, or brass.

23. The heat recovery system (1) according to claim 1, wherein each parallel tube (4.1) comprises at least one turbulator (5) selected from a twisted tape turbulator (5.1), a matrix turbulator (5.2), a rod with a plurality of spheres arranged along its length (5.3), a wire spring (5.4), a wire spring (5.5) in a pipe in pipe configuration of parallel tubes (4.1), a coil shaped tape spring (5.6), a c-shaped element comprising holes (5.7), a rod comprising a plurality of delta wing vortex generators (5.8) or a screw shaped turbulator (5.9).

24. The heat recovery system (1) according to claim 1, wherein the inlet (4.3) and outlet (4.4) are arranged inside the holes for tubes (2.3) of the hollow case (2).

25. The heat recovery system (1) according to claim 1, wherein the hollow housing (2) has a length between 300 and 900 mm, width between 100 and 400 mm and a height between 30 and 90 mm.

26. The heat recovery system (1) according to claim 1, wherein the protuberances (2.4) have a height between 0.1 and 10 mm.

27. The heat recovery system (1) according to claim 26, wherein the protuberances (2.4) have a double wave shape with a higher height suitable to receive alternating parallel tubes (4.1).

28. The heat recovery system (1) according to claim 1, wherein heat exchanger (4) has a length between 200 and 800 mm, width between 90 and 390 mm and a height between 10 and 50 mm.

29. The heat recovery system (1) according to claim 1, wherein heat exchanger system (1) when using double walled parallel tubes (4.1) comprises a leakage detect system that is a gap between the walls.

30. (canceled)
